(19) United States
(12) Patent Application Publication
(10) Pub. No.: US 2026/0119979 A1
(43) Pub. Date: Apr. 30, 2026

(54) DEVICE AND METHOD FOR PROCESSING TASKS THROUGH MODEL-BASED OFFLINE LEARNING

(71) Applicant: UIF (UNIVERSITY INDUSTRY FOUNDATION), YONSEI UNIVERSITY, Seoul (KR)

(72) Inventors: Youngwoon Lee, Seoul (KR); Kwanyoung Park, Seoul (KR)

(73) Assignee: UIF (UNIVERSITY INDUSTRY FOUNDATION), YONSEI UNIVERSITY, Seoul (KR)

(21) Appl. No.: 18/933,828

(22) Filed: Oct. 31, 2024

(30) Foreign Application Priority Data
Oct. 30, 2024 (KR) 10-2024-0151576

(51) Int. Cl. G06N 20/00

(52) U.S. Cl. CPC G06N 20/00

(57) ABSTRACT

Disclosed is a device and method for processing tasks through model-based offline learning. The device includes: a dataset input unit configured to receive an offline dataset for offline reinforcement learning; an initialization unit configured to initialize a world model and a model generation dataset for predicting a state transition and a reward without interacting with a real environment; a model rollout unit configured to expand the offline data of the offline dataset based on the world model to generate an imagined trajectory and generate imaginary data of the model generation dataset; and a learning update unit configured to perform critic update and actor update based on the offline data and the imaginary data.

### CROSS-REFERENCE TO RELATED APPLICATION

This application claims under 35 U.S.C. § 119(a) the benefit of Korean Patent Application No. 10-2024-0151576 filed on Oct. 30, 2024, the entire contents of which is incorporated herein by reference.

### TECHNICAL FIELD

The present disclosure relates to a task processing technology, and more particularly, to a device and method for processing tasks through model-based offline learning, which generates imagined trajectories from offline data and performs critic update and actor update based on offline data and imagined data.

### BACKGROUND

Offline reinforcement learning aims to solve reinforcement learning problems using only pre-collected datasets and has shown better performance compared to behavioral cloning policies. Offline reinforcement learning can easily apply off-policy reinforcement learning algorithms on a fixed dataset, but off-policy methods face the issue of overestimating Q-values for actions not seen in the offline dataset. This occurs because an overestimated value function is not corrected through online environment interactions in offline reinforcement learning.

To address this, model-free offline reinforcement learning algorithms aim to resolve the issue of overestimated Q-values by either constraining the policy to select only actions present in the offline data or adopting conservative value estimates when executing actions not present in the dataset. While these algorithms demonstrate strong performance on standard offline reinforcement learning benchmarks, model-free offline reinforcement learning policies are often limited by a supported data range (i.e., the state-action pairs in the offline dataset) and may have limited generalization ability.

In response, model-based offline reinforcement learning approaches seek to overcome these limitations by better utilizing limited offline data. These approaches learn a world model and generate synthetic data that includes actions outside the supported data range through the learned model. This model can be learned from both offline data and model rollouts, similar to Dyna-style online model-based reinforcement learning. However, these models may be inaccurate for states and actions outside the supported data range, which can make the policy prone to exploitation.

### PRIOR ART LITERATURE

### Patent Document

Korean Patent Application Publication No. 2024-0077642 (Jun. 3, 2024)

### SUMMARY

### Problem to be Solved

In view of the above, the present disclosure provides a device and method for processing tasks through model-based offline learning, which can expand offline data of an offline dataset based on a world model to generate an imagined trajectory and generate imaginary data of a model generation dataset.

The present disclosure also provides a device and method for processing tasks through model-based offline learning, which can select arbitrary offline data from an offline dataset and perform expansion through assumption about a state and action of the selected offline data.

The present disclosure also provides a device and method for processing tasks through model-based offline learning, which can generate an imagined trajectory by predicting a reward and a next state based on assumption about a state and an action.

### Solution

In one aspect, there is provided a device for processing tasks through model-based offline learning, and the device includes: a dataset input unit configured to receive an offline dataset for offline reinforcement learning; an initialization unit configured to initialize a world model and a model generation dataset for predicting a state transition and a reward without interacting with a real environment; a model rollout unit configured to expand the offline data of the offline dataset based on the world model to generate an imagined trajectory and imaginary data of the model generation dataset; and a learning update unit configured to perform critic update and actor update based on the offline data and the imaginary data.

The dataset input unit may receive offline data composed of state-action-reward-next state tuples as the offline dataset.

The initialization unit may learn a world model through the offline dataset and pre-learn a policy for a specific action that makes up the world model and a value of the specific action.

The initialization unit may clear the model generation dataset to add the imaginary data to the model generation dataset.

The model rollout unit may select arbitrary offline data from the offline dataset and perform the expansion by assuming a state and action of the selected offline data.

The model rollout unit may generate the imagined trajectory by predicting a reward and a next state based on the state and action derived through the assumption.

The model rollout unit may determine the imaginary data on the imagination trajectory and add the imaginary data to the model generation dataset.

The learning update unit may learn an expected reward function based on states and actions for the offline data and the state data through the critic update.

The learning update unit may learn a policy to select an optimal action based solely on the imaginary data through the actor update.

In another aspect, there is provided method for processing tasks through model-based offline learning, performed by a device for processing tasks through model-based offline learning, and the method includes: a dataset input step for receiving an offline dataset for offline reinforcement learning; an initialization step for initializing a world model and a model generation dataset for a predicting state transition and a reward without interacting with a real environment; a model rollout step for expanding the offline data of the offline dataset based on the world model to generate an imagined trajectory and imaginary data of the model generation dataset; and a learning update step for performing critic update and actor update based on the offline data and the imaginary data.

### Effect

The disclosed technology may have the following effects. However, it should not be construed that the scope of the disclosed technology is limited by the following effects, as it does not mean that a specific embodiment must include all or only the following effects.

In a device and method for processing tasks through model-based offline learning according to one embodiment of the present disclosure, it is possible to expand offline data of an offline dataset based on a world model to generate an imagined trajectory and imaginary data of a model generation dataset.

In the device and method for processing tasks through model-based offline learning according to one embodiment of the present disclosure, it is possible to select arbitrary offline data from an offline dataset and perform expansion through assumption about a state and action of the selected offline data.

In the device and method for processing tasks through model-based offline learning according to one embodiment of the present disclosure, it is possible to generate an imagined trajectory by predicting a reward and a next state based on assumption about a state and an action.

### BRIEF DESCRIPTION OF THE DRAWINGS

FIG. 1 is a drawing illustrating a Lower Expectile Q-learning algorithm according to one embodiment of the present disclosure.

FIG. 2 is a diagram illustrating the functional configuration of a device for processing tasks through model-based offline learning according to one embodiment of the present disclosure.

FIG. 3 is a flowchart illustrating a method for processing tasks through model-based offline learning according to one embodiment of the present disclosure.

FIG. 4 is a diagram illustrating an LEQ learning algorithm using λ-return according to one embodiment of the present disclosure.

FIG. 5 is a diagram illustrating a λ-return and critic update according to one embodiment of the present disclosure.

FIGS. 6A and 6B are drawings illustrating the MuJoCo motion control tasks and the AntMaze tasks according to one embodiment of the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

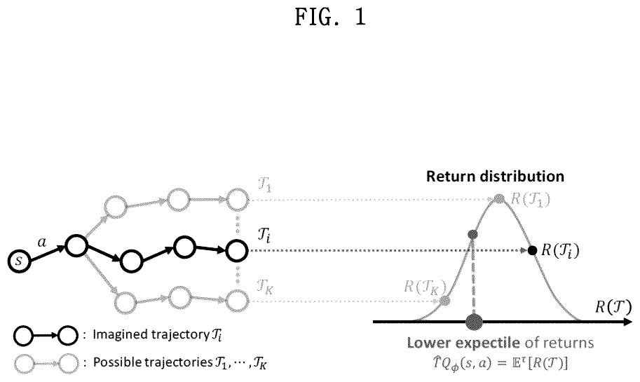

FIG. 1 is a drawing illustrating a Lower Expectile Q-learning algorithm according to one embodiment of the present disclosure.

Referring to FIG. 1, in order to solve long-term tasks through model-based offline reinforcement learning, a model-based offline reinforcement learning algorithm called Lower Expectile Q-learning (LEQ) is introduced. LEQ may perform conservative Q-value estimation by applying expectile regression with small τ values for policy and Q-function learning. Additionally, LEQ may optimize the policy and Q-function using λ-returns (i.e., TD(λ) target) and long (15-step) model rollouts to better handle long-term tasks, allowing the policy to learn the model directly from multi-step returns with low bias. Experimental results on the D4RL AntMaze, MuJoCo Gym task, and NeoRL benchmarks show that conservative policy optimization using λ-returns and critic learning from offline data significantly improves offline reinforcement learning policies on long-term tasks, while achieving similar performance on short-term tasks and sparse reward tasks. In particular, LEQ is observed to be the first model-based offline reinforcement learning algorithm that equals or outperforms model-free offline reinforcement learning algorithms on the AntMaze long-term task.

Here, the LEQ model-based offline reinforcement learning algorithm may estimate the target value of Q_{φ}(s, a) when a←π_{θ}(s) by rolling over the world model ensemble and averaging r(s, a)+γQ_{φ}(s′, a′) over all possible s′. Here, the target value computed from the model-generated data may be defined by the following Equation.

$${\hat{y}}_{model} = {𝔼}_{ψ \sim \{ {ψ}_{1} , … , {ψ}_{M} \}} {𝔼}_{( {s}^{′} , r ) \sim {p}_{ψ} ( \cdot \vert s , a )} [ r + γ {Q}_{ϕ} ( {s}^{′} , {π}_{θ} ( {s}^{′} ) ) ] . \qquad [ Equation 1 ]$$

Here, the target value may have three sources of error, including the predicted future state, the reward s′, r˜p_{Ψ}(⋅|s, a), and the future Q-value Q_{φ}(s′, π_{θ}(s′)) Therefore, the target value \hat{γ}_{model} calculated from the model-generated data is more likely to be overestimated than the original target Q-value ŷₑₙᵥ calculated from (s, a, r, s′)˜Dₑₙᵥ:|. Here, the target Q-value may be defined by the following Equation.

$${\hat{y}}_{env} = r + γ {Q}_{ϕ} ( {s}^{′} , {π}_{θ} ( {s}^{′} ) ) . \qquad [ Equation 2 ]$$

Here, expectile regression with a small value of τ may be proposed to mitigate the overestimation problem that occurs in the process of estimating the true Q-value from the inaccurate world model rollout in H-stage. Expectile regression with a small value of τ tends to select a target Q-value that is lower than the expected value, effectively providing a conservative target Q-value estimate. Another advantage of using expectile regression is that expectation regression does not require a comprehensive evaluation of the Q-value to obtain the predicted value of T, but rather allows for conservative estimation through sampling. Here, the expectile regression model may be defined mathematically as follows.

$${L}_{Q , model} ( ϕ ) = {𝔼}_{{s}_{0} ∈ {𝒟}_{model , τ \sim {p}_{ψ} , {π}_{θ}}} [ \frac{1}{H} {\sum }_{t = 0}^{H} {L}_{2}^{τ} ( {Q}_{ϕ} ( {s}_{t} , \vert {π}_{θ} ( {s}_{t} ) ) - {\hat{y}}_{model} ) ] . \qquad [ Equation 3 ]$$

In addition, the Q-function may be learned on offline data Denv using standard Bellman update. The equation for the standard Bellman updated Q-function may be defined as follows.

$${ℒ}_{Q , env} ( ϕ ) = {𝔼}_{( s , a , r , {s}^{′} ) ∈ {𝒟}_{env}} [ \frac{1}{2} {( {Q}_{ϕ} ( s , a ) - {\hat{y}}_{env} )}^{2} ] . \qquad [ Equation 4 ]$$

To stabilize the learning of the Q-function, EMA normalization may be adopted to prevent sudden changes in the Q-values and normalize the difference between the Q-predicted value and each Q-value from the exponential moving average. The normalized Q-value may be defined mathematically as follows:

$${ℒ}_{Q , EMA} ( ϕ ) = {𝔼}_{( s , a ) ∈ {𝒟}_{env}} [ {( {Q}_{ϕ} ( s , a ) - {Q}_{\overline{ϕ}} ( s , a ) )}^{2} ] , \qquad [ Equation 5 ]$$

Here, φ̅ may correspond to an exponential moving average of φ. It is important to note that by using EMA normalization, the target Q-network are not used for equations 1 and 2. Lastly, by combining the three losses in Equations 3 through 5 above, the critic loss may be defined as follows.

$${ℒ}_{Q} ( ϕ ) = {βℒ}_{Q , model} ( ϕ ) + ( 1 - β ) {ℒ}_{Q , env} ( ϕ ) + {β}_{EMA} {ℒ}_{Q , EMA} ( ϕ ) . \qquad [ Equation 6 ]$$

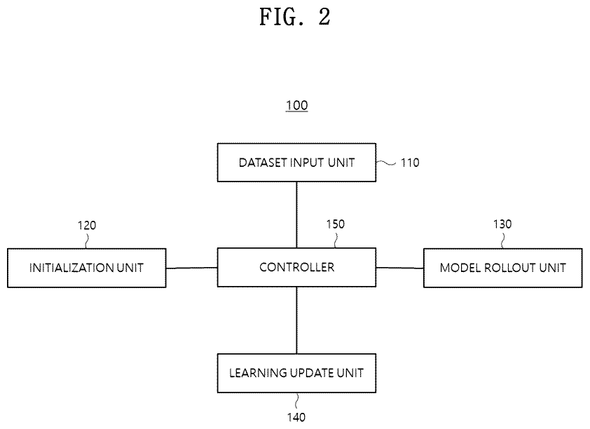

FIG. 2 is a drawing illustrating a device for processing tasks through model-based offline learning according to one embodiment of the present disclosure.

Referring to FIG. 2, a device 100 for processing tasks through model-based offline learning may include a dataset input unit 110, an initialization unit 120, a model rollout unit 130, a learning update unit 140, and a controller 150.

At this time, the embodiments of the present disclosure are not required to include all of the aforementioned components simultaneously and may be implemented by omitting some of the components or selectively incorporating some or all of them, depending on the specific embodiment. Below, the operation of each component is described in detail.

The dataset input unit 110 may receive an offline dataset for offline reinforcement learning. Here, the offline dataset may refer to a dataset collected in the past and may be composed of tuples, such as a state experienced previously, an action taken in the state, a corresponding reward, and a next state. The dataset input unit 110 may extract an offline dataset for offline reinforcement learning from past action data executed by an agent in a real environment. Here, the dataset input unit 110 is not necessarily limited thereto and may receive an offline dataset for offline reinforcement learning from a simulation environment or an existing reinforcement learning policy.

In one embodiment, the dataset input unit 110 may receive offline data composed of state-action-reward-next state tuples as an offline dataset. The dataset input unit 110 may perform offline reinforcement learning based on offline data composed of state-action-reward-next state tuples. For example, the dataset input unit 110 may receive an offline dataset that includes a state tuple containing a vehicle's location, speed, and traffic conditions in an autonomous driving scenario, an action tuple representing acceleration, deceleration, and lane changes by the vehicle, and a reward tuple evaluated based on criteria such as compliance with traffic laws and collision avoidance.

The initialization unit 120 may initialize a world model and a model generation dataset for predicting a state transition and a reward without interacting with a real environment. Here, the world model may refer to a simulation model that helps the system learn autonomously without interacting with the real environment. For example, the world model may provide a virtual environment that predicts a state transition and a reward system based on an offline dataset. The initialization unit 120 initializes the world model and the model generation dataset and may predict a next state and a reward based on a specific action in a current state. For example, the initialization unit 120 may simulate a specific action in a virtual environment by performing learning based on an offline dataset through a world model. Here, the initialization unit 120 may prevent learning distortion caused by unnecessary information by initializing the world model and the model generation dataset, followed by initializing previous data, and then perform a learning process on the offline dataset.

In one embodiment, the initialization unit 120 may learn a world model through an offline dataset and pre-learn a policy for a specific action that makes up the world model and a value of the specific action. Here, a policy may correspond to a rule and function that determine which action to take in a given state, and a value may correspond to a reward level for performing a specific action. The initialization unit 120 may assign a policy and a value to a specific action by learning a world model through an offline dataset. For example, the initialization unit 120 may simulate a specific action in a virtual environment based on a world model and learn a policy and value for the action based on a result of the action.

In one embodiment, the initialization unit 120 may clear the model generation dataset to add imaginary data to the model generation dataset. Here, the imaginary data may refer to virtual data generated through a world model in a simulated environment. By adding a state and action, predicted using a virtual trajectory, to the model generation dataset, the initialization unit 120 may implement a state and action that is unlikely to occur in a real environment. In addition, the initialization unit 120 may learn a policy and a value for a specific action by simulating the specific action under various conditions based on imaginary data. In one embodiment, the initialization unit 120 may clear the model generation dataset before adding the imaginary data to remove old or unnecessary data and prevent biases according to a specific pattern of the dataset.

The model rollout unit 130 may expand offline data of an offline dataset based on a world model to generate an imagined trajectory and imaginary data of a model generation dataset. Here, the model rollout unit 130 may generate imaginary data that predicts a virtual state-action-reward-next state relationship for a specific action through the world model. For example, the model rollout unit 130 may generate an imagined trajectory by repeatedly selecting an arbitrary state-action-reward-next state tuple from the offline data and predicting a next state and reward for a specific action through the world model. The model rollout unit 130 may update an offline dataset by adding virtual data generated through an imagined trajectory to the model generation dataset.

In one embodiment, the model rollout unit 130 may select arbitrary offline data from the offline dataset and perform expansion by assuming a state and action for the selected offline data. Here, the model rollout unit 130 may predict a result of state transition and action for arbitrary offline data based on the world model. For example, in autonomous driving, the model rollout unit 130 may extend offline data by making various assumptions about an action of accelerating or decelerating when a vehicle is at an intersection and simulating a state transition and a reward for the action.

In one embodiment, the model rollout unit 130 may generate an imagined trajectory by predicting a reward and a next state based on the state and action through assumptions. Here, the model rollout unit 130 may set assumptions about a current state and an action that may be taken in the current state based on offline data. Next, the model rollout unit 130 may generate an imagined trajectory by predicting a reward for the corresponding action based on a degree of compliance with the policy and predicting the next state according to the reward. For example, the model rollout unit 130 may provide a high reward for compliance with traffic laws for a vehicle passing through an intersection while adhering to a set speed limit, according to a policy in an autonomous driving scenario.

In one embodiment, the model rollout unit 130 may determine imaginary data along the imagination trajectory and add the imaginary data to the model generation dataset. Here, the model rollout unit 130 may store the state-action-reward-next state pairs generated at each stage in the model generation dataset. The model rollout unit 130 may adjust a value predicted by the model to prevent over-optimism through conservative Q-value evaluation during the generation of imaginary data. Here, the Q-value is a predictor of the value for a given state and action, and may be pre-learned by the Q-function. Additionally, the model rollout unit 130 may learn the Q-function more conservatively using expectile regression to reduce the possibility of overestimating a predicted Q-value. Here, the expectile regression may be considered a statistical technique to predict a value at a specific expectile level. The model rollout unit 130 may prevent overestimation of the Q-value by learning the Q-function based on the expected reward in a specific section of the reward distribution based on the expectile regression.

The learning update unit 140 may perform critic update and actor update based on offline data and imaginary data. Here, the critic update could correspond to a process of learning the Q-function, and may serve, for example, to evaluate how large a reward the agent can expect to receive when taking a predetermined action in a given state. Additionally, the actor updating may correspond to a process of learning a policy that allows the agent to select the optimal action given a given state. The learning update unit 140 may improve reward prediction for state-action pairs by performing critic update based on offline data and imaginary data. For example, the learning update unit 140 may calculate a next state and an expected reward in the state based on the predicted imaginary data through the world model.

Additionally, the learning update unit 140 may update the policy based on the critic's feedback through actor update and determine the optimal action in a given state. Here, the learning update unit 140 may determine the optimal action to take in the current state, by performing a policy update based on the reward prediction data generated through the critic update. For example, the learning update unit 140 may update a policy based on a trajectory predicted from imaginary data through actor update, and explore a new policy based on a state-to-action transition that has not actually been experienced.

In one embodiment, the learning update unit 140 may learn an expected reward function based on a state and action for offline data and state data through critic update. Here, the expected reward function may correspond to a function representing an expected total reward that an action will yield in the future for a given state-and-action pair, and may also correspond to a Q-function. The learning update unit 140 may learn an expected reward function based on states and actions using λ-returns during the process of performing a critic update. For example, the learning update unit 140 may learn long-term rewards by estimating better Q-values by considering rewards over multiple stages through λ-returns.

In one embodiment, the learning update unit 140 may learn a policy to select the optimal action based solely on imaginary data through actor update. Here, the learning update unit 140 may adjust the probability for selecting an action that may maximize a future reward in each state based on the Q-value calculated through critic update. For example, the learning update unit 140 may learn a policy to select an optimal action according to imaginary data by performing actor update through a policy gradient method. Here, the policy gradient method may correspond to a technique for parameterizing a policy and optimizing parameters.

The controller 150 controls the overall operation of the device 100 for processing tasks through model-based offline learning, and may manage the control or data flow between the dataset input unit 110, initialization unit 120, model rollout unit 130, and learning update unit 140.

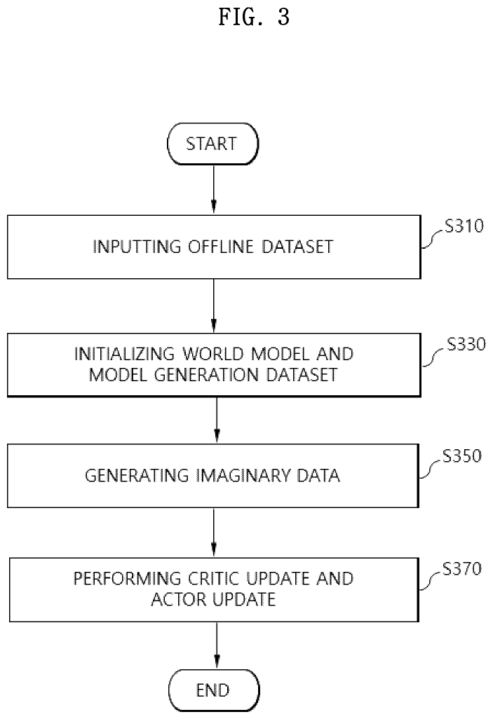

FIG. 3 is a flowchart illustrating a method for processing tasks through model-based offline learning according to the present disclosure.

Referring to FIG. 3, a device 100 for processing tasks through model-based offline learning may receive an offline dataset for offline reinforcement learning through a dataset input unit 110 (step S310). The device 100 may initialize a world model and model generation dataset for predicting state transitions and rewards, without interacting with an real environment, through the initialization unit 120 (step S330).

The device 100 may expand offline data of an offline dataset using the world model to generate an imagined trajectory and imaginary data of the model generation dataset, through the model rollout unit 130, (step S350). The device 100 may perform critic update and actor update based on the offline data and the imaginary data through a learning update unit 140 (step S370).

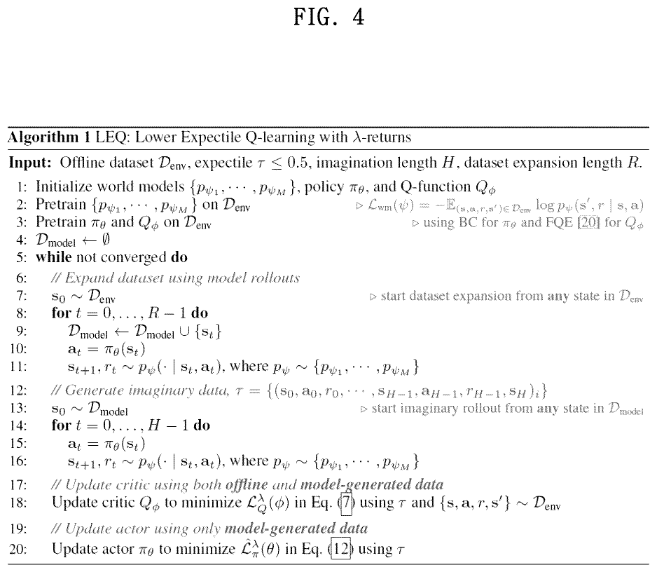

FIG. 4 is a diagram illustrating an LEQ learning algorithm using λ-return according to one embodiment of the present disclosure.

In FIG. 4, the LEQ learning algorithm may conservatively learn a policy and Q-function by utilizing expectile regression and multi-step λ-return through the model generation data in offline reinforcement learning. Hereinafter, each stage of the LEQ learning algorithm will be described.

### 1. Input Stage

A fixed offline dataset containing state, action, reward, and next state information, collected by the agent through interaction with the real environment, is input. Here, the offline dataset may correspond to [symbol] ₑₙᵥ. Additionally, conservative Q-values are learned by entering the parameter T, which is used in expectile regression. Here, the smaller the value of T, the more conservative the Q-value may be estimated.

By inputting the length H of the imagined trajectory, the agent determines how many steps of state transitions to generate in the imagination, and the length R of the dataset expansion allows the agent to decide an amount of new data to generate using the learned model.

### 2. Initialization Stage

After initializing the world model {p_{Ψ1}, . . . , p_{ΨM}} the world model {p_{Ψ1}, . . . , p_{ΨM}} is pre-trained using the offline dataset [symbol] ₑₙᵥ. This allows the world model to be learned using the offline data, allowing the agent to generate imaginary data without interacting with the environment. In addition, the policy πθ and Q-function Q_{φ} may also be pre-trained using the offline dataset [symbol] ₑₙᵥ through Behavioral Cloning (BC) and Fitted Q Evaluation (FQE).

Lastly, by clearing the model generation dataset [symbol] _{model}, an empty dataset for generating imaginary data in the initial state may be set up. Data may be added to the empty dataset later through model rollouts.

### 3. Main Loop Stage

First, dataset expansion is performed by selecting an arbitrary state from the offline dataset [symbol] ₑₙᵥ and generating new state transitions by iterating over the expansion length R. Here, dataset expansion may use the learned world model {_{Ψ1}, . . . , p_{ΨM}} to select an action aₜ from the current state sₜ according to the policy π_{θ}(sₜ). Then, the next state Sₜ₊₁ and reward rₜ may be predicted from the current state sₜ and the results are added to the model generation dataset [symbol] _{model}. Then, imaginary data to imagine new state transitions may be generated by selecting an arbitrary state s₀ from the model generation dataset [symbol] _{model} and iterating over the length H of the imagined trajectory.

Critic update is performed and the Q-function Q_{φ} is updated using offline data and model generation data. Here, the critic update is performed to minimize the loss function [symbol] (φ) and Q-values are learned more conservatively. In addition, the Q-function is improved using the state-action-reward-next-state tuples collected from the offline dataset. Then, actor update is performed and the policy π_{θ} updated using the model generation data. Here, the actor update improves the policy π_{θ} in a way to minimize the policy loss [symbol] (θ) based on imaginary data, thereby learning the policy to select more conservative and reliable actions.

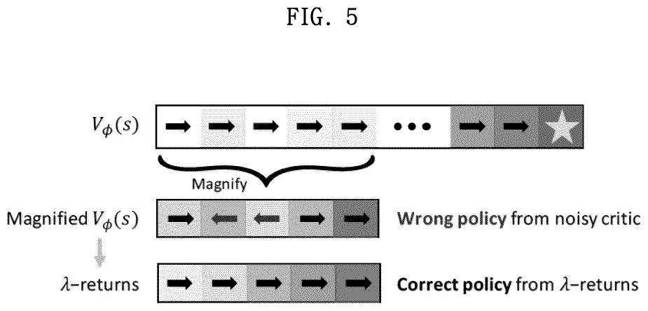

FIG. 5 is a diagram illustrating a λ-return and critic update according to one embodiment of the present disclosure.

In FIG. 5, to further improve LEQ in long-term tasks, λ-return is used in Q-learning instead of the 1-step return. λ-return allows the Q-function and policy to reduce bias in value estimation through low-bias multi-step returns. First, the λ-return

$${Q}_{t}^{λ} ( τ )$$

of the trajectory τ at time t may be defined using the N-step return G_{t:t+N} (τ). The λ-return

$${Q}_{t}^{λ} ( τ )$$

of the trajectory τ at time t is defined by Equation 7.

$${G}_{t : t + N} ( τ ) = {\sum }_{i = 0}^{N - 1} {γ}^{i} r ( {s}_{t + i} , {a}_{t + i} ) + {γ}^{N} {Q}_{ϕ} ( {s}_{t + N} , {a}_{t + N} ) , \qquad [ Equation 7 ]$$

$${Q}_{t}^{λ} ( τ ) = \frac{1 - λ}{1 - {λ}^{H - t - 1}} {\sum }_{i = 1}^{H - t} {λ}^{i - 1} {G}_{t : t + i} ( τ ) .$$

Next, by replacing the 1-step return in Equation 3 with the λ-return, the Q-learning loss may be redefined as shown in Equation 8. Equation 8 is as follows: Equation 8 is as follows:

$${ℒ}_{Q , model}^{λ} ( ϕ ) = {𝔼}_{{s}_{0} ∈ {𝒟}_{model} , τ \sim {p}_{ψ} , {π}_{θ}} [ {\sum }_{t = 0}^{H - 1} {L}_{2}^{τ} ( {Q}_{ϕ} ( {s}_{t} , {π}_{θ} ( {s}_{t} ) ) - {Q}_{t}^{λ} ( τ ) ) ] . \qquad [ Equation 8 ]$$

Additionally, for policy optimization, a deterministic policy a=π_{θ}(s) may be used, and similarly to DDPG, a deterministic policy gradient may be applied to update the policy. Instead of maximizing the immediate Q-value Q_{φ}(s, a), it is suggested in the following Equation 9 to directly maximize the lower expectile of the λ-return, which serves as a more accurate learning objective for the policy, similar to a conservative critic objective.

$${ℒ}_{π}^{λ} ( θ ) = - {𝔼}_{{s}_{0} ∈ {𝒟}_{model} , τ \sim {p}_{ψ} , {π}_{θ}} [ {\sum }_{t = 0}^{H} {𝔼}_{τ \sim {p}_{ψ} , {π}_{θ}}^{τ} [ {Q}_{t}^{λ} ( τ ) ] ] . \qquad [ Equation 9 ]$$

However, since it is difficult to calculate the gradient of [symbol] (θ) in Equation 9 due to the expectile term, a differentiable surrogate loss is proposed as in Equation 10 by approximating [symbol] in Equation 9 with

$${𝔼}_{τ \sim {p}_{ψ} , {π}_{θ}}^{τ} [ {Q}_{t}^{λ} ( τ ) ]$$

to estimate the gradient.

$${\hat{ℒ}}_{π}^{λ} ( θ ) = - {𝔼}_{{s}_{0} ∈ {𝒟}_{model} , τ \sim {p}_{ψ} , {π}_{θ}} [ {\sum }_{t = 0}^{H} \vert τ - 𝕝 ( {Q}_{ϕ} ( {s}_{t} , {s}_{t} ) > {Q}_{t}^{λ} ( τ ) ) \vert \cdot {Q}_{t}^{λ} ( τ ) ] . \qquad [ Equation 10 ]$$

Intuitively, this surrogate loss guides the policy to optimize the conservative λ-return estimate

$$( i . e . , {Q}_{ϕ} ( {s}_{t} , {a}_{t} ) > {Q}_{t}^{λ} ( τ ) )$$

by assigning a higher weight (1—τ). On the other hand, the optimistic λ-return estimate

$$( i . e . , {Q}_{ϕ} ( {s}_{t} , {a}_{t} ) < {Q}_{t}^{λ} ( τ ) )$$

influences the policy with a smaller weight T. Therefore, by optimizing this surrogate loss, the policy maximizes the lower expected value of the λ-return.

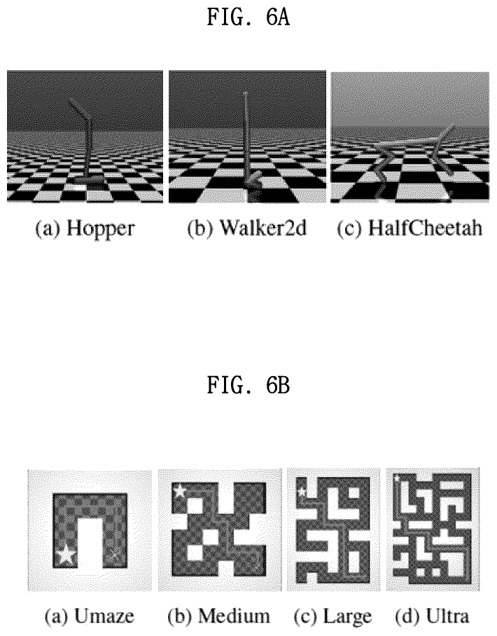

FIGS. 6A and 6B are drawings illustrating the MuJoCo motion control tasks and the AntMaze tasks according to one embodiment of the present disclosure.

Referring to FIGS. 6A and 6B, experiments are conducted on the MuJoCo motor control task and the AntMaze task to evaluate the performance of an offline reinforcement learning method that performs conservative value estimation. Here, MuJoCO may correspond to the robot motion control task performed in the MuJoCo (Multi-Joint dynamics with Contact) simulator. The experimental procedure was carried out as follows.

For the MuJoCo motion control task, offline reinforcement learning with fine-grained rewards is evaluated using the D4RL and NeoRL training datasets, as shown in FIG. 6A. Additionally, in FIG. 6B, an experiment is conducted to make an ant robot with 8 degrees of freedom move to a target location using the umaze, medium, large, and ultra datasets from D4RL.

Next, the performance of LEQ is compared with a state-of-the-art offline reinforcement learning algorithm. LEQ used the same hyperparameters for all tasks except the expectation parameter. (τ)

In model-free offline reinforcement learning, Behavioral Cloning (BC), TD3+BC (which combines BC loss with TD3), CQL (which penalizes actions outside the data distribution), and IQL (which estimates the value function using expectation regression) are considered. For the motor control task, the comparison is performed with including EDAC which provides a penalty based on the uncertainty of the Q-function.

In model-based offline reinforcement learning, the following are considered: MOPO which penalizes Q-values based on transfer uncertainty; MOBILE which penalizes based on Bellman uncertainty of the world model; COMBO which combines CQL with MBPO; RAMBO which learns an adversarial world model against the policy; and CBOP which uses λ-return for critic update.

The MuJoCo motion control task is derived as shown in Table 1 below.

TABLE 1

| | Model-free | | | | | Model-based | | | | | |
|---|---|---|---|---|---|---|---|---|---|---|---|
| Dataset | BC | TD3 + BC | CQL | EDAC | IQL | MOPO* | COMBO | RAMBO | MOBILE | CBOP | LEQ (ours) |
| hopper-r | 3.7 | 8.5 | 5.3 | 25.3 | 7.6 | 31.7 | 17.9 | 25.4 | 31.0 | 32.8 | 32.4_{±0.3} |
| hopper-m | 54.1 | 59.3 | 61.9 | 101.6 | 66.3 | 62.8 | 97.2 | 87.0 | 106.6 | 102.6 | 103.4_{±0.3} |
| hopper-mr | 16.6 | 60.9 | 86.3 | 101.0 | 94.7 | 99.4 | 103.5 | 89.5 | 99.5 | 104.3 | 103.9_{±1.3} |
| hopper-me | 53.9 | 98.0 | 96.9 | 110.7 | 91.5 | 81.6 | 111.1 | 88.2 | 112.6 | 111.6 | 109.4_{±1.8} |
| walker2d-r | 1.3 | 1.6 | 5.4 | 16.6 | 5.2 | 7.4 | 7.0 | 0.0 | 17.9 | 17.8 | 21.5_{±0.1} |
| walker2d-m | 70.9 | 83.7 | 79.5 | 92.5 | 78.3 | 81.3 | 84.1 | 81.9 | 84.9 | 87.7 | 74.9_{±26.9} |
| walker2d-mr | 20.3 | 81.8 | 76.8 | 87.1 | 73.9 | 85.6 | 56.0 | 89.2 | 89.9 | 92.7 | 98.7_{±6.0} |
| walker2d-me | 90.1 | 110.1 | 109.1 | 114.7 | 109.6 | 112.9 | 103.3 | 56.7 | 115.2 | 117.2 | 108.2_{±1.3} |
| halfcheetah-r | 2.2 | 11.0 | 31.3 | 28.4 | 11.8 | 38.5 | 38.8 | 39.5 | 39.3 | 32.8 | 30.8_{±3.3} |
| halfcheetah-m | 43.2 | 48.3 | 46.9 | 65.9 | 47.4 | 73.0 | 54.2 | 77.9 | 74.6 | 74.3 | 71.7_{±4.4} |
| halfcheetah-mr | 37.6 | 44.6 | 45.3 | 61.3 | 44.2 | 72.1 | 55.1 | 68.7 | 71.7 | 66.4 | 65.5_{±1.1} |
| halfcheetah-me | 44.0 | 90.7 | 95.0 | 106.3 | 86.7 | 90.8 | 90.0 | 95.4 | 108.2 | 105.4 | 102.8_{±0.4} |
| Total | 437.9 | 698.5 | 739.7 | 911.4 | 717.2 | 844.0 | 802.0 | 812.4 | 959.5 | 953.4 | 923.2 |

In the MuJoCo motor control tasks, LEQ achieves results similar to the best scores from previous studies in 6 out of 12 tasks. Additionally, the NeoRL benchmarks in Table 2 demonstrate superior performance compared to most previous studies in the Hopper and Walker2d domains. These results demonstrate that LEQ is not limited to long-term tasks and may serve as a general offline reinforcement learning algorithm. Here, the NeoRL benchmarks are as shown in Table 2 below.

TABLE 2

| | Model-free | | | | | Model-based | | |
|---|---|---|---|---|---|---|---|---|
| Dataset | BC | TD3 + BC | CQL | EDAC | IQL | MOPO* | MOBILE | LEQ (ours) |
| Hopper-L | 15.1 | 15.8 | 16.0 | 18.3 | 16.7 | 6.2 | 17.4 | 24.2_{±2.3} |
| Hopper-M | 51.3 | 70.3 | 64.5 | 44.9 | 28.4 | 1.0 | 51.1 | 104.3_{±5.2} |
| Hopper-H | 43.1 | 75.3 | 76.6 | 52.5 | 22.3 | 11.5 | 87.8 | 95.5_{±13.9} |
| Walker2d-L | 28.5 | 43.0 | 44.7 | 40.2 | 30.7 | 11.6 | 37.6 | 65.1_{±2.3} |
| Walker2d-M | 48.7 | 58.5 | 57.3 | 57.6 | 51.8 | 39.9 | 62.2 | 45.2_{±19.4} |
| Walker2d-H | 72.6 | 69.6 | 75.3 | 75.5 | 76.3 | 18.0 | 74.9 | 73.7_{±1.1} |
| HalfCheetah-L | 29.1 | 30.0 | 38.2 | 31.3 | 30.7 | 40.1 | 54.7 | 33.4_{±1.6} |
| HalfCheetah-M | 49.0 | 52.3 | 54.6 | 54.9 | 51.8 | 62.3 | 77.8 | 59.2_{±3.9} |
| HalfCheetah-H | 71.4 | 75.3 | 77.4 | 81.4 | 76.3 | 65.9 | 83.0 | 71.8_{±8.0} |
| Total | 408.8 | 490.1 | 504.6 | 456.6 | 385.0 | 256.5 | 546.5 | 572.4 |

Here, the LEQ and IQL results may be averaged over the five seeds.

LEQ achieves high performance most of the time during learning, but occasionally drops to 0 unexpectedly. This is primarily because the learned model fails to capture failures adequately (e.g., hopper and walker falling) and instead predicts an optimistic future (e.g., hopper and walker moving forward).

Additionally, the results of the AntMaze task are derived as shown in Table 3 below.

TABLE 3

| | Model-free | | | | Model-based | | | | | |
|---|---|---|---|---|---|---|---|---|---|---|
| Dataset | BC | TD3 + BC | CQL | IQL | MOPO | COMBO | RAMBO | MOBILE^{†} | CBOP^{†} | LEQ (ours) |
| antmaze-unmaze | 65.0 | 78.6 | 74.0 | 87.5 | 0.0 | 80.3 | 25.9 | 0.0_{±0.0} | 0.0_{±0.0} | 94.4_{±6.3} |
| antmaze-unmaze-diverse | 55.0 | 71.4 | 84.0 | 62.2 | 0.0 | 57.3 | 0.0 | 0.0_{±0.0} | 0.0_{±0.0} | 71.0_{±12.3} |
| antmaze-medium-play | 0.0 | 3.0 | 61.2 | 71.2 | 0.0 | 0.0 | 16.4 | 0.0_{±0.0} | 0.0_{±0.0} | 58.8_{±33.0} |
| antmaze-medium-diverse | 0.0 | 10.6 | 53.7 | 70.0 | 0.0 | 0.0 | 23.2 | 0.0_{±0.0} | 0.0_{±0.0} | 46.2_{±23.2} |
| antmaze-large-play | 0.0 | 0.0 | 15.8 | 39.6 | 0.0 | 0.0 | 0.0 | 0.0_{±0.0} | 0.0_{±0.0} | 58.6_{±9.1} |
| antmaze-large-diverse | 0.0 | 0.2 | 14.9 | 47.5 | 0.0 | 0.0 | 2.4 | 0.0_{±0.0} | 0.0_{±0.0} | 60.2_{±18.3} |
| antmaze-ultra-play | — | — | — | 8.3 | — | — | — | 0.0_{±0.0} | 0.0_{±0.0} | 25.8_{±18.2} |
| antmaze-ultra-diverse | — | — | — | 15.6 | — | — | — | 0.0_{±0.0} | 0.0_{±0.0} | 55.8_{±18.3} |
| Total w/o antmaze-ultra | 120.0 | 163.8 | 303.6 | 354.1 | 0.0 | 137.6 | 67.0 | 0.0 | 0.0 | 388.8 |
| Total | — | — | — | 378.0 | — | — | — | 0.0 | 0.0 | 470.4 |

^{†}We use the official implementation of MOBILE and CBOP.

As shown in Table 3, LEQ significantly outperforms previous model-based approaches on all eight datasets. LEQ achieves scores of 58.6 and 60.2 on antmaze-large-play and antmaze-large-diverse, respectively, while the second-best method, RAMBO, only score 0.0 and 2.4, respectively. This performance improvement appears to stem from a more stable conservative value estimation compared to the uncertainty-based penalties of previous studies.

Additionally, LEQ significantly outperforms model-free approaches on antmaze-umaze, antmaze-large, and antmaze-ultra. Despite the excellent performance, LEQ exhibits high variance during learning, which may lead to degraded performance on antmaze-medium. LEQ generally achieves high success rates during learning but occasionally produces evaluation results that drop to 0%.

To understand why LEQ (LEQ-A) works well in long-term tasks, an ablation study is conducted.

First, to evaluate the effect of λ-return, LEQ-λ is compared with 1-step return (LEQ-1) and H-step return (LEQ-H) versions. As shown in Table 4, using λ-return significantly improves performance in AntMaze compared to 1-step or H-step returns. This result is consistent with observations from previous online reinforcement learning methods. Table 4 is as follows.

TABLE 4

| | unmaze | | medium | | large | | ultra | | |
|---|---|---|---|---|---|---|---|---|---|
| Dataset | unmaze | diverse | play | diverse | play | diverse | play | diverse | Total |
| LEQ-λ (ours) | 94.4_{±6.3} | 71.0_{±12.3} | 58.8_{±33.0} | 46.2_{±23.2} | 58.6_{±9.1} | 60.2_{±18.3} | 25.8_{±18.2} | 55.8_{±18.3} | 470.4 |
| LEQ-H | 93.0_{±3.4} | 60.7_{±10.4} | 46.3_{±32.4} | 0.0_{±0.0} | 57.0_{±25.6} | 33.3_{±43.0} | 0.0_{±0.0} | 0.0_{±0.0} | 200.3 |
| LEQ-1 | 89.6_{±4.8} | 37.0_{±32.8} | 55.8_{±28.7} | 29.8_{±24.5} | 34.2_{±13.4} | 49.3_{±9.0} | 42.2_{±13.2} | 35.6_{±13.0} | 373.5 |
| MOBIP-λ | 84.3_{±3.5} | 40.3_{±20.4} | 51.3_{±9.0} | 39.7_{±12.5} | 28.3_{±21.5} | 33.7_{±10.0} | 38.0_{±27.1} | 23.3_{±4.9} | 338.9 |
| MOBIP-1 | 59.5_{±3.5} | 46.5_{±1.5} | 57.0_{±11.0} | 54.0_{±9.0} | 23.5_{±19.5} | 38.5_{±1.5} | 39.5_{±11.5} | 20.5_{±20.5} | 339.0 |
| MOBILE* | 1.0_{±2.0} | 0.0_{±0.0} | 6.4_{±5.5} | 5.0_{±9.0} | 0.8_{±1.6} | 0.8_{±1.2} | 0.0_{±0.0} | 0.0_{±0.0} | 14.0 |
| MOBILE* (β = 0.25) | 77.0_{±6.4} | 20.4_{±15.7} | 64.6_{±11.1} | 31.6_{±16.9} | 2.6_{±2.8} | 7.2_{±8.9} | 4.6_{±3.0} | 5.0_{±4.6} | 213.0 |
| MOBILE* (γ = 0.997) | 0.0_{±0.0} | 0.0_{±0.0} | 7.2_{±4.1} | 1.6_{±2.1} | 9.6_{±7.1} | 5.4_{±4.9} | 0.0_{±0.0} | 1.8_{±2.7} | 25.6 |
| MOBILE* (R = 10) | 0.0_{±0.0} | 0.0_{±0.0} | 5.0_{±5.1} | 0.6_{±1.2} | 7.4_{±14.8} | 1.6_{±3.2} | 0.0_{±0.0} | 0.0_{±0.0} | 14.6 |

Next, LEQ is compared with MOBIP, another conservative value estimator used by MOBILE. MOBIP is defined by the standard deviation of the Q-ensemble network, which penalizes the Q-value. The difference between LEQ and MOBIP lies in how the target Q-value is calculated for critic and policy update. In Table 4, it is confirmed that using MOBIP not only reduces the success rate (especially in MOBIP-1) but also provides no advantage for λ-return (MOBIP-λ).

Next, to investigate why offline model-based reinforcement learning works in AntMaze tasks, the changes in LEQ when running offline model-based reinforcement learning in AntMaze is examined. First, MOBILE is reimplemented using technical tricks employed in LEQ (LayerNorm, SymLog, single Q-network, and no target Q-value clipping), but MOBILE achieves a score of 14.0, which is almost as negligible as 0. Thus, it is confirmed that the key factor enabling MOBILE to function effectively is reducing β, which is the ratio of the loss computed in virtual rollouts to the loss computed by dataset transitions. Here, when β is reduced from 0.95 to 0.25 (as used in LEQ), MOBILE shows meaningful performance on the umaze and medium mazes, achieving a total score of 213.0. This suggests that leveraging actual transitions from the dataset is crucial for long-horizon tasks.

Finally, an investigation is conducted on the imaginary length H and the dataset extension length R. As shown in Table 5, performance improves when H increases from 5 to 10 but deteriorates when H reaches 15. This result suggests that as an agent imagines further using a world model, the robustness to critic errors increases, but the vulnerability to model prediction errors also grows. Table 5 is as follows.

TABLE 5

| Dataset | H = 10, R = 5 (ours) | H = 5, R = 5 | H = 15, R = 5 | H = 10, R = 1 |
|---|---|---|---|---|
| antmaze-umaze | 94.4 ± 6.3 | 95.2 ± 1.7 | 98.6 ± 0.5 | 97.4 ± 1.4 |
| antmaze-umaze-diverse | 71.0 ± 12.3 | 67.2 ± 9.1 | 70.7 ± 15.2 | 63.0 ± 23.2 |
| antmaze-medium-play | 58.8 ± 33.0 | 46.4 ± 31.9 | 76.3 ± 17.2 | 58.2 ± 28.0 |
| antmaze-medium-diverse | 46.2 ± 23.2 | 18.6 ± 28.7 | 30.3 ± 40.1 | 28.6 ± 33.7 |
| antmaze-large-play | 58.6 ± 9.1 | 48.6 ± 15.4 | 62.0 ± 9.9 | 56.0 ± 9.8 |
| antmaze-large-diverse | 60.2 ± 18.3 | 35.2 ± 8.7 | 33.0 ± 3.2 | 57.0 ± 4.5 |
| antmaze-ultra-play | 25.8 ± 18.2 | 54.2 ± 10.8 | 0.0 ± 0.0 | 39.2 ± 15.1 |
| antmaze-ultra-diverse | 55.8 ± 18.3 | 39.4 ± 6.1 | 0.0 ± 0.0 | 36.0 ± 12.0 |
| Total | 470.4 | 404.8 | 371.0 | 435.4 |

Here, LEQ (H=10, R=1) is evaluated without dataset expansion. The result show that in AntMaze, the performance is similar regardless of whether dataset expansion was applied. However, in the D4RL MuJoCo task, dataset expansion leads to a stable policy and superior performance.

The above description is merely exemplary description of the technical scope of the present disclosure, and it will be understood by those skilled in the art that various changes and modifications can be made without departing from the spirit and scope of the present disclosure as set forth in the following claims.

### [National Research and Development Project Supporting The Present Invention]

[Project Serial No] 2710006677
[Task Project No] RS-2020-II201361
[Name of Department] Ministry of Science and ICT
[Task Management (Professional) Institution Name] Institute of Information and Communications Technology Planning and Evaluation
[Research Project Name] Nurturing ICT and Broadcasting Innovation Talents
[Research Task Title] Artificial Intelligence Graduate School Support (Yonsei University)
[Name of Project Performing Organization] Yonsei University Industry-University Cooperation Foundation
[Research Period] 2024.01.01˜2024.12.31

[Detailed Description of Main Elements]

| | |
|---|---|
| 100: device for processing tasks through | |
| model-based offline learning | |
| 110: dataset input unit | 120: initialization unit |
| 130: model rollout unit | 140: learning update unit |
| 150: controller | |

1. A device for processing tasks through model-based offline learning, the device comprising:
a dataset input unit configured to receive an offline dataset for offline reinforcement learning;
an initialization unit configured to initialize a world model and a model generation dataset for predicting a state transition and a reward without interacting with a real environment;
a model rollout unit configured to expand the offline data of the offline dataset based on the world model to generate an imagined trajectory and generate imaginary data of the model generation dataset; and
a learning update unit configured to perform critic update and actor update based on the offline data and the imaginary data.

2. The device of claim 1, wherein the dataset input unit receives offline data composed of state-action-reward-next state tuples as the offline dataset.

3. The device of claim 1, wherein the initialization unit learns a world model through the offline dataset and pre-learns a policy for a specific action that makes up the world model and a value of the specific action.

4. The device of claim 2, wherein the initialization unit clears the model generation dataset to add the imaginary data to the model generation dataset.

5. The device of claim 1, wherein the model rollout unit selects arbitrary offline data from the offline dataset and performs the expansion by assuming a state and action of the selected offline data.

6. The device of claim 5, wherein the model rollout unit generates the imagined trajectory by predicting a reward and a next state based on the state and action derived through the assumption.

7. The device of claim 6, wherein the model rollout unit determines the imaginary data on the imagination trajectory and adds the imaginary data to the model generation dataset.

8. The device of claim 1, wherein the learning update unit learns an expected reward function based on states and actions for the offline data and state data through the critic update.

9. The device of claim 1, wherein the learning update unit learns a policy to select an optimal action based solely on the imaginary data through the actor update.

10. A method for processing tasks through model-based offline learning, performed by a device for processing tasks through model-based offline learning, the method comprising:
a dataset input step for receiving an offline dataset for offline reinforcement learning;
an initialization step for initializing a world model and a model generation dataset for predicting a state transition and a reward without interacting with a real environment;
a model rollout step for expanding the offline data of the offline dataset based on the world model to generate an imagined trajectory and generate imaginary data of the model generation dataset; and
a learning update step for performing critic update and actor update based on the offline data and the imaginary data.
